(19) United States
(12) Patent Application Publication
(10) Pub. No.: US 2024/0193513 A1
(43) Pub. Date: Jun. 13, 2024

(54) DATA INTEGRATION SYSTEM AND METHOD

(71) Applicant: Express Scripts Strategic Development, Inc., St. Louis, MO (US)

(72) Inventors: Timothy Vires, Saint Charles, MO (US); David Timson, St. Peters, MO (US)

(21) Appl. No.: 18/077,591

(22) Filed: Dec. 8, 2022

(51) Int. Cl. G06Q 10/0631

(52) U.S. Cl. CPC G06Q 10/06313

(57) ABSTRACT

A system and method for integrating data from different data sources is disclosed. Project records are processed by (a) calculating a normalized level of effort value based on a level of effort value contained in the project record and (b) determining a cost center identifier associated with the project record. Cost center records are processed by (a) identifying the project records associated with a cost center identifier contained in the cost center record and (b) allocating an expense amount contained in the cost center record across the identified project records based on the normalized level of effort value for each of the identified project records.

### BACKGROUND OF THE INVENTION

### 1. Field of the Invention

The present disclosure is generally related to data processing systems and, more particularly, to systems that enable the integration of data from different data sources.

### 2. Description of Related Art

Organizations use different types of business application software in connection with operation of their businesses. For example, it is common for organizations to use general ledger accounting software that aggregates financial transactions across cost centers and provides data to generate consolidated financial reports. Each cost center has a sub-ledger account in the general ledger that includes expenses for different types of accounts, such as salaries and wages, travel, and the like.

Some organizations also use project management software to plan, assign, track, report and otherwise manage their projects. In agile software development, for example, a business may use a project management tool to define themes, epics, features and stories. A theme is a collection of smaller epics that share a common goal or objective of the business. An epic is a large body of work that includes a number of features each of which includes a series of smaller stories. Each story is a small unit of development work that enables a project team to complete a particular task. The project management tool enables management of a multitude of projects and, in particular, the individual stories for each project.

While the different types of business application software used by organizations are suitable for performing specific tasks, it may not be possible to integrate the data generated by different software to achieve certain business objectives. Thus, there remains a need in the art for improved data integration technology that overcomes some or all of the drawbacks associated with existing systems and/or that offers other advantages compared to such existing systems.

### BRIEF SUMMARY OF THE INVENTION

The present invention is directed to systems and methods for integrating data from different data sources. In exemplary embodiments, a data integration system is provided that integrates project data generated by a project management system with accounting data generated by an accounting system. The project data is stored as a plurality of project records each of which contains a project identifier for a project, a team identifier for a team assigned to the project, and a level of effort value indicative of an overall effort required for the team to complete the project (sometimes referred to as story points). The accounting data is stored as cost center records each of which contains a cost center identifier, an account type identifier, and an expense amount. The same cost center identifier may be associated with multiple records each of which contains an expense amount for a different account type.

In one aspect, the data integration system processes the project records designated as completed during a particular time period. Each project record is processed by calculating a normalized level of effort value based on the level of effort value contained in the project record. Each project record is also processed by determining a cost center identifier associated with the project record. For example, a table may be maintained that associates team identifiers with cost center identifiers. In this case, the table may be accessed to determine at least one cost center identifier associated with the team identifier contained in the project record.

In some embodiments, the normalized level of effort values for the project records are calculated as part of a normalization function applied to all of the project records associated with the same team identifier. In some embodiments, the normalization function for a particular team identifier comprises identifying the project records associated with the team identifier, which is referred to as a team group. The normalized level of effort value for each of the project records in the team group is then calculated by (i) calculating a standardized level of effort value for each of the project records in the team group, (ii) determining an adjustment value to be applied to all of the project records, and (iii) adding the adjustment value to the standardized level of effort value for each of the project records in the team group. Some standardized level of effort values will have negative values and others will have positive values. The adjustment value causes the minimum (smallest) standardized level of effort value of all of the project records associated with all of the team identifiers to shift from a negative value to a positive value so that all of the normalized level of effort values have positive values.

In another aspect, the data integration system processes the cost center records for expenses incurred during a particular time period. Each cost center record is processed by identifying the project records associated with the cost center identifier contained in the cost center record, which is referred to as a cost center group. The expense amount contained in the cost center record is then allocated across the cost center group based on the normalized level of effort value for each of the project records in the cost center group. In some embodiments, this allocation step is performed by (i) summing the normalized level of effort values for the project records in the cost center group to obtain a total normalized level of effort value for the cost center group, (ii) determining a multiplier for each of the project records in the cost center group, wherein the multiplier for each project record comprises a percentage representing the normalized level of effort value for the project record in relation to the total normalized level of effort value for the cost center group, and (iii) applying the multiplier for each of the project records in the cost center group to the expense amount to determine an allocated expense amount for each of the project records in the cost center group.

The data integration system is thus able to integrate the project data generated by a project management system with accounting data generated by an accounting system so that the expenses associated with each cost center can be allocated to specific projects. This functionality is not provided by existing systems that do not support the integration of data from different data sources.

Various embodiments of the present invention are described in detail below, or will be apparent to one skilled in the art based on the disclosure provided herein, or may be learned from the practice of the invention. It should be understood that the above brief summary of the invention is not intended to identify key features or essential components of the embodiments of the present invention, nor is it intended to be used as an aid in determining the scope of the claimed subject matter as set forth below.

### BRIEF DESCRIPTION OF THE DRAWINGS

A detailed description of various exemplary embodiments of the present invention is provided below with reference to the following drawings, in which:

FIG. 1 is a block diagram of a system for integrating project data from a project management system and cost center data from an accounting system in accordance with one embodiment of the invention;

FIG. 2 is a block diagram of the data integration system shown in FIG. 1;

FIG. 3 is a process flow diagram of an exemplary data integration method performed by the data integration system shown in FIG. 2;

FIG. 4 is a process flow diagram of an exemplary method for processing project records that may be performed as part of the method shown in FIG. 3;

FIG. 5 is a process flow diagram of an exemplary method for processing cost records that may be performed as part of the method shown in FIG. 3;

FIG. 6 is a process flow diagram of an exemplary normalization function performed by the data integration system shown in FIG. 2;

FIG. 7 depicts a table showing exemplary project records stored in the project management database shown in FIG. 2;

FIG. 8 depicts a portion of a team identifier/cost center identifier table stored in the reference table database shown in FIG. 2;

FIG. 9 depicts the table shown in FIG. 7 in which each project record is modified to add the normalized level of effort value and cost center identifier;

FIG. 10 depicts a table showing exemplary cost center records stored in the cost center database shown in FIG. 2;

FIG. 11 depicts a portion of an account type/cost type table stored in the reference table database shown in FIG. 2;

FIG. 12 depicts the table shown in FIG. 9 in which each cost center record is modified to add the cost type;

FIG. 13 depicts a table showing the exemplary project records shown in FIG. 9 integrated with the exemplary cost center records shown in FIG. 12;

FIG. 14 depicts a portion of the table shown in FIG. 13 in which a multiplier is used to determine the portion of the expense allocated to each integrated record;

FIG. 15 depicts the table shown in FIG. 14 in which row numbers are added to enable generation of reports;

FIG. 16 depicts an exemplary report showing total costs by project;

FIG. 17 depicts an exemplary report showing total costs by account type;

FIG. 18 depicts an exemplary report showing a total project cost by account type; and

FIG. 19 depicts a table showing application of an exemplary normalization function.

### DETAILED DESCRIPTION OF EXEMPLARY EMBODIMENTS

The present invention is directed to systems and methods for integrating data from different data sources. While the invention will be described in detail below with reference to various exemplary embodiments, it should be understood that the invention is not limited to the specific system configurations or methods of these embodiments. In addition, although the exemplary embodiments are described as embodying several different inventive features, one skilled in the art will appreciate that any one of these features could be implemented without the others in accordance with the invention.

In the present disclosure, references to “one embodiment,” “an embodiment,” “an exemplary embodiment,” or “embodiments” mean that the feature or features being described are included in at least one embodiment of the invention. Separate references to “one embodiment,” “an embodiment,” “an exemplary embodiment,” or “embodiments” in this disclosure do not necessarily refer to the same embodiment and are also not mutually exclusive unless so stated and/or except as will be readily apparent to one skilled in the art from the description. For example, a feature, structure, function, etc. described in one embodiment may also be included in other embodiments, but is not necessarily included. Thus, the present invention can include a variety of combinations and/or integrations of the embodiments described herein.

An exemplary embodiment of the present invention will now be described in which a data integration system is used to integrate project data generated by a project management system with accounting data generated by an accounting system so that the expenses associated with each cost center can be allocated to specific projects. Of course, it should be understood that the invention is not limited to the exemplary embodiment described below and that the data integration system could be used in a variety of different implementations.

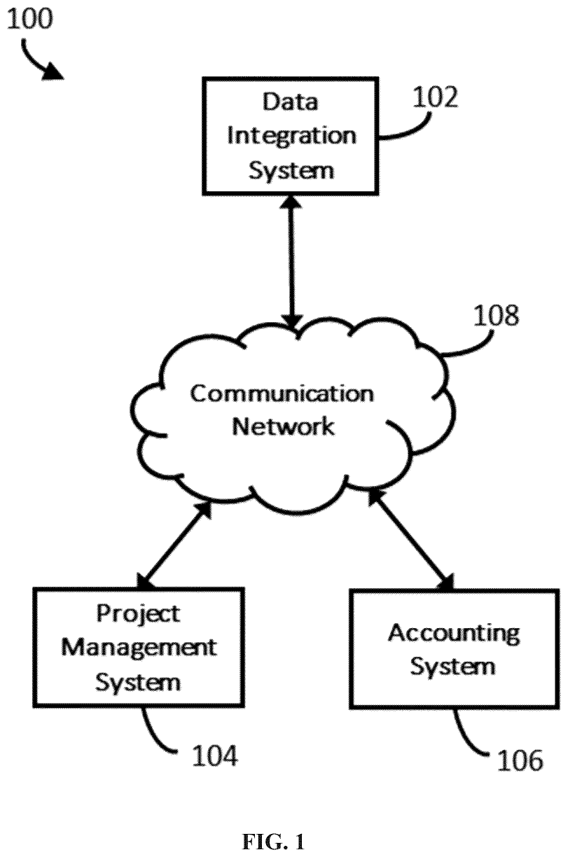

Referring to FIG. 1, one embodiment of a system for integrating project data and cost center data in accordance with the present invention is shown generally as reference number 100. System 100 includes a data integration system 102, a project management system 104, and an accounting system 106, which communicate with each other via a communication network 108. Communication network 108 may comprise any network or combination of networks capable of facilitating the exchange of data between data integration system 102 and each of project management system 104 and accounting system 106. In some embodiments, communication network 108 enables communication in accordance with the IEEE 802.3 protocol (e.g., Ethernet) and/or the IEEE 802.11 protocol (e.g., Wi-Fi). Of course, other types of networks may also be used. It should be understood that data integration system 102, project management system 104 and accounting system 106 may be either co-located in the same geographic location or located in different geographic locations in accordance with the present invention.

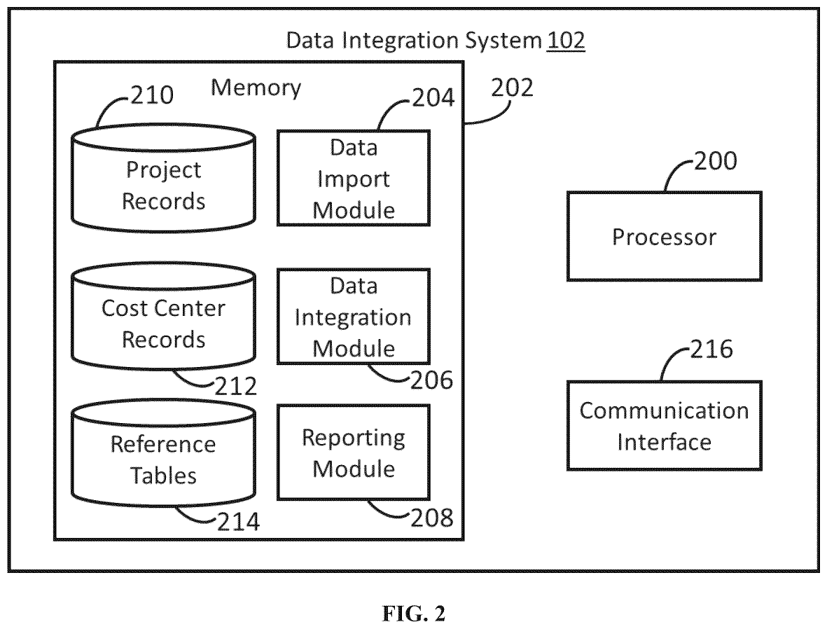

FIG. 2 is a block diagram illustrating an exemplary embodiment of data integration system 102. Data integration system 102 includes a processor 200 that is operatively connected to various hardware and software components, including a memory 202 and a communication interface 216. Processor 200 may comprise a multi-core processor, multiple processors, or some other type of processor, depending on the particular implementation.

Memory 202 may include any suitable combination of volatile memory (e.g., random-access memory (RAM)) and non-volatile memory (e.g. read-only memory (ROM), electrically erasable programmable read-only memory (EEPROM), or flash memory). Memory 202 stores various software applications or modules, including data import module 204, data integration module 206, and reporting module 208, each of which comprises instructions that, when executed by processor 200, cause processor 200 to perform the methods described herein. Memory 202 also stores various types of data, including project records stored in a project database 210, cost center records stored in a cost center database 212, and various reference tables stored in reference database 214.

Data import module 204 enables the importation of project data from project management system 10 and stores the data as project records in project database 210. The data elements for each project record may include a variety of different types of information, such as: (1) a project identifier for a project, (2) a team identifier for a team assigned to the project, (3) a level of effort (LOE) value indicative of an overall effort required for the team to complete the project (referred to as “story points” in some project management systems), (4) a business sponsor for the project, (5) an initiative type for the project, and/or (6) a month or other time period during which the project was completed. In this embodiment, the project identifier and team identifier each comprise a unique identifier (UID) so as to uniquely identify the project and project team, respectively. Of course, it should be understood that each project record may include other types of data in accordance with the present invention.

Data import module 204 also enables the importation of accounting data from accounting system 106 and stores the data as cost center records in cost center database 212. The data elements for each cost center record may include a variety of different types of information, such as: (1) a cost center identifier, (2) an account type identifier, (3) an expense amount, and/or (4) a month or other time period during which the expense was incurred. In this embodiment, the cost center identifier comprises a unique identifier (UID) so as to uniquely identify the cost center. The same cost center identifier may be associated with multiple cost center records each of which contains an expense amount for a different account type. The account types may comprise, for example, salaries and wages, travel, statement of work (SOW), rent and facilities, training and education, etc. Of course, it should be understood that each cost center record may include other types of data in accordance with the present invention.

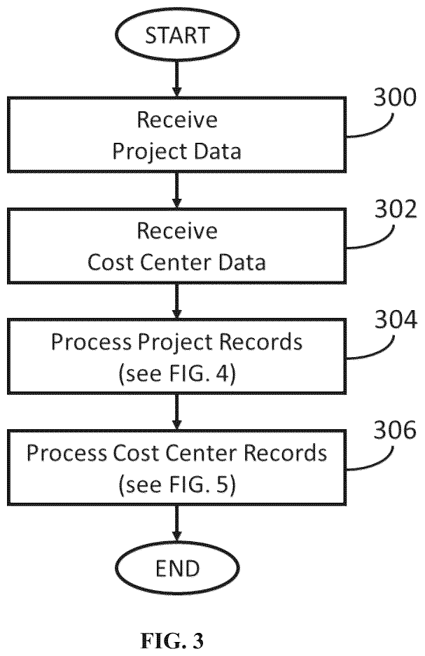

Data integration module 206 enables integration of the data contained in the project records stored in project database 210 and the data contained in the cost center records stored in cost center database 212. It will be seen that the data integration process involves access to reference database 214, which includes different references tables. One reference table contains all of the team identifiers from the project management system 104 cross-referenced to the cost center identifiers from the accounting system 106—i.e., each team identifier is associated with a cost center identifier. Another reference table contains all of the account types from accounting system 106 cross-referenced to cost types (e.g., labor, non-labor, SOW, etc.). Once the data is integrated and stored in new tables, reporting module 208 enables the generation of various reports relating to the integrated data. The methods performed by data integration module 206 and reporting module 208 will be described in greater detail below in connection with FIGS. 3-19.

In the exemplary embodiment, project database 210, cost center database 212, and reference database 214 each comprise a Structured Query Language (SQL) database having a table-based data structure. Each table is comprised of a collection of rows and columns, wherein each row corresponds to a record and each column is associated with an attribute of the record. Data import module 204, data integration module 206 and reporting module 208 are able to access the data stored in project database 210, cost center database 212, and reference database 214 using SQL scripts. Of course, other data structures may also be used within the scope of the present invention.

Communication interface 216 may be any interface that enables communication between data integration system 102 and each of project management system 104 and accounting system 106 via communication network 108. In some embodiments, communication interface 216 comprises a network interface card (NIC), an integrated network interface, and/or any other interfaces for connecting data integration system 102 to other systems and/or communication networks. Such connections can include a wired connection or a wireless connection.

Referring back to FIG. 1, project management system 104 comprises any server or computer system with project management software that enables the management of projects, such as Jira® available from Atlassian Pty. Ltd. of Sydney, Australia. Accounting system 106 comprises any server or computer system with accounting software that enables the aggregation of financial transactions across cost centers and provides data to generate consolidated financial reports, such as general ledger accounting software. In this embodiment, project management system 104 and accounting system 106 comprise pre-existing systems, and data integration system 102 provides a technical solution that enables the integration of data generated by these pre-exiting systems. In other embodiments, all or a portion of the methods performed by data integration system 102 are provided as features of project management system 104 and/or accounting system 106—i.e., one or both of the pre-existing systems are modified to perform the methods described herein.

Referring to FIG. 3, an exemplary data integration method performed by data integration system 102 in accordance with one embodiment of the present invention is described with reference to steps 300-306.

In step 300, data import module 204 receives project data from project management system 104 and stores the data as project records in project database 210. In this embodiment, each of the project records contains a project identifier for a project, a team identifier for a team assigned to the project, a level of effort (LOE) value indicative of an overall effort required for the team to complete the project, a business sponsor for the project, an initiative type for the project, and the month during which the project was completed. It should be understood that the project data may be obtained from one or more data sources within project management system 104 and processed by data import module 204 to generate the project records.

In step 302, data import module 204 receives accounting data from accounting system 106 and stores the accounting data as cost center records in cost center database 212. In this embodiment, each of the cost center records contains a cost center identifier, an account type identifier, an expense amount, and the month during which the expense was incurred. It should be understood that the accounting data may be obtained from one or more data sources within accounting system 106 and processed by data import module 204 to generate the cost center records.

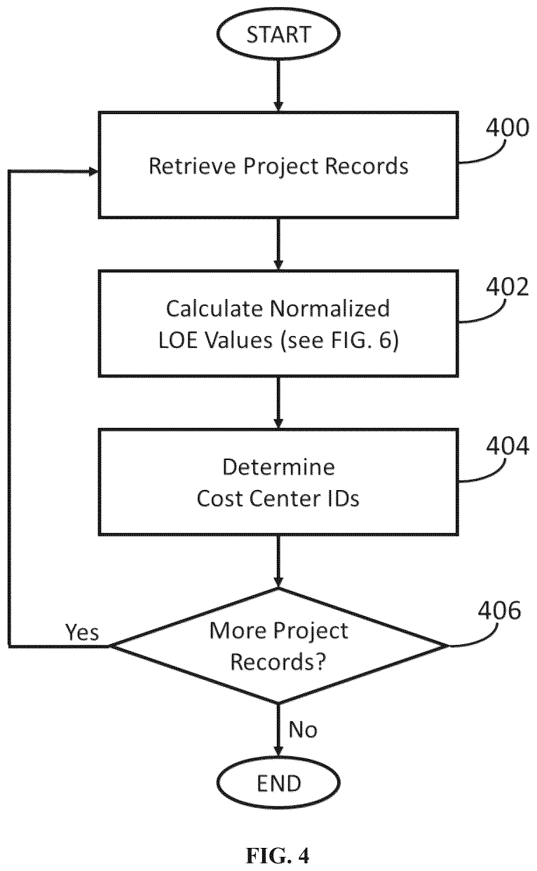

In step 304, data integration module 206 processes all or a portion of the project records stored in project database 210. In this embodiment, the project records that are processed comprise the project records associated with a particular month (e.g., March 2022). Of course, other groups of project records may be processed within the scope of the present invention. The processing method of step 304 will be described in greater detail below in connection with FIG. 4.

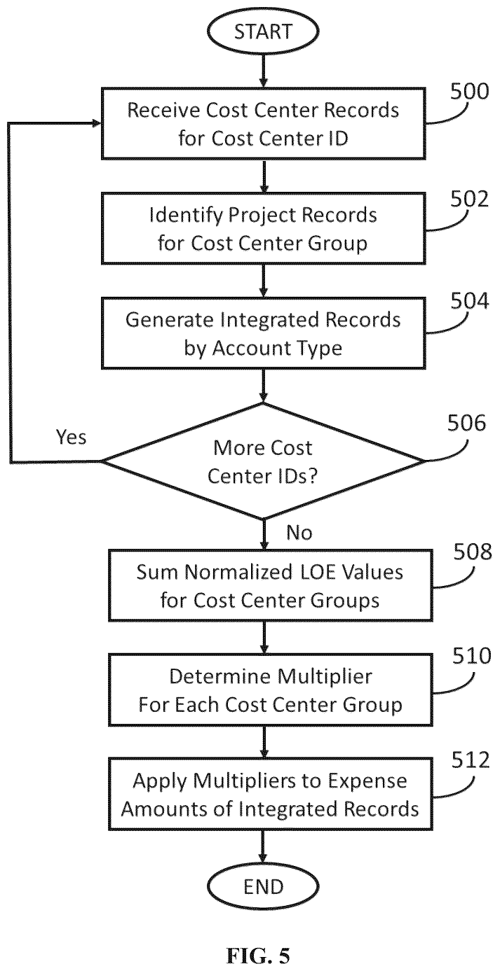

In step 306, data integration module 206 processes all or a portion of the cost center records stored in cost center database 212. In this embodiment, the cost center records that are processed comprise the cost center records associated with a particular month (e.g., March 2022). Of course, other groups of cost center records may be processed within the scope of the present invention. The processing method of step 306 will be described in greater detail below in connection with FIG. 5.

It will be seen that the processing of the project records in step 304 and the processing of the cost center records in step 306 causes the integration of the data contained in these records so that the expenses associated with each cost center can be allocated to specific projects.

Referring to FIG. 4, an exemplary method for processing project records performed by data integration system 102 in accordance with one embodiment of the present invention is described with reference to steps 400-406. It should be understood that this method corresponds to step 304 of FIG. 3.

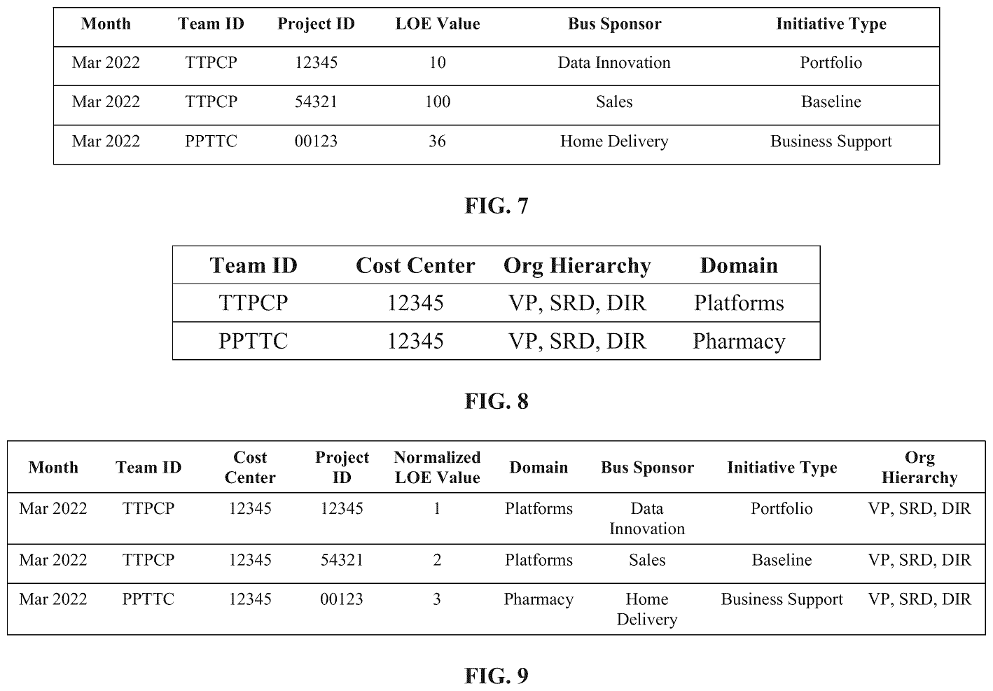

In step 400, data integration module 206 retrieves a set of project records from project database 210. In this embodiment, the project records to be processed are associated with a set time period. An example set of project records is shown in FIG. 7, which includes the project records with the project identifiers of 12345, 54321 and 00123 that were completed in March 2022. While this set only includes three project records for the sake of simplicity, it should be understood that a set may have any number of project records—e.g., the number of project records in a set will typically fall in the range of about 20,000 to 36,000 records per month.

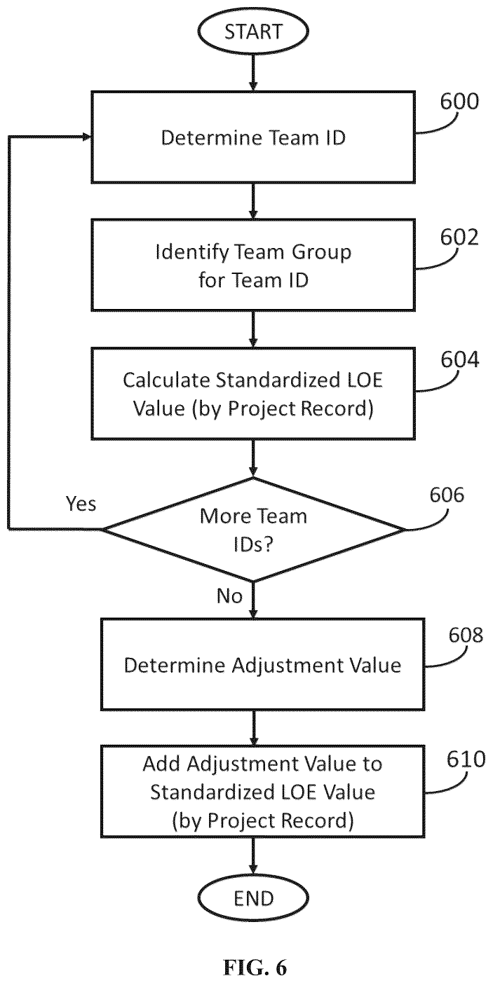

In step 402, data integration module 206 utilizes a normalization function to calculate a normalized level of effort (LOE) value for each of the project records in the set. In this example, the project record with the project identifier of 12345 is determined to have a normalized LOE value of 1, the project record with the project identifier of 54321 is determined to have a normalized LOE value of 2, and the project record with the project identifier of 00123 is determined to have a normalized LOE value of 3. It should be noted that the project record with the project identifier of 00123 has the highest normalized LOE value of the set-even higher than the project record with the project identifier of 54321 that has the highest LOE value of the set. This result is due to the manner in which the normalization function is applied, i.e. the normalization function is applied to project records associated with the same team identifier for the set time period. In this case, the first two project records with the team identifier of TTPCP are analyzed in a first team group, while the third project record with the team identifier of PPTTC is analyzed in a second team group. Application of the normalization function to project records on a team group-by-team group basis provides normalized LOE values that account for differences between varying scales and the manner in which different teams determine the LOE values for projects. The normalization function is described in greater detail below in connection with FIG. 6.

In step 404, data integration module 206 determines the cost center identifier for each of the project records in the set. In this embodiment, data integration module 206 makes this determination by accessing the team identifier/cost center identifier reference table in reference database 214—i.e., the reference table containing all of the team identifiers from the project management system 104 cross-referenced to the cost center identifiers from the accounting system 106. An example reference table is shown in FIG. 8, which shows that the team identifier TTPCP is associated with the cost center identifier 12345 and the team identifier PPTTC is also associated with the cost center identifier 12345. It should be understood that other team identifiers may be associated with other cost center identifiers. In some embodiments, a team identifier may be associated with two or more cost center identifiers, in which case each cost center identifier is assigned a percentage indicating how much of the team is associated with that cost center identifier. It can be seen that other data may optionally be provided in the reference table, such as the organization hierarchy and domain associated with the team identifier.

The table shown in FIG. 9 depicts the project records of FIG. 7 as modified to add the normalized level of effort values calculated in step 402 and the cost center identifiers determined in step 404.

In step 406, it is determined whether there is another set of project records to be processed (e.g., the project records associated with a different month or other time period). If so, the process returns to step 400. Otherwise, the process ends.

Referring to FIG. 5, an exemplary method for processing cost center records performed by data integration system 102 in accordance with one embodiment of the present invention is described with reference to steps 500-512. It should be understood that this method corresponds to step 306 of FIG. 3.

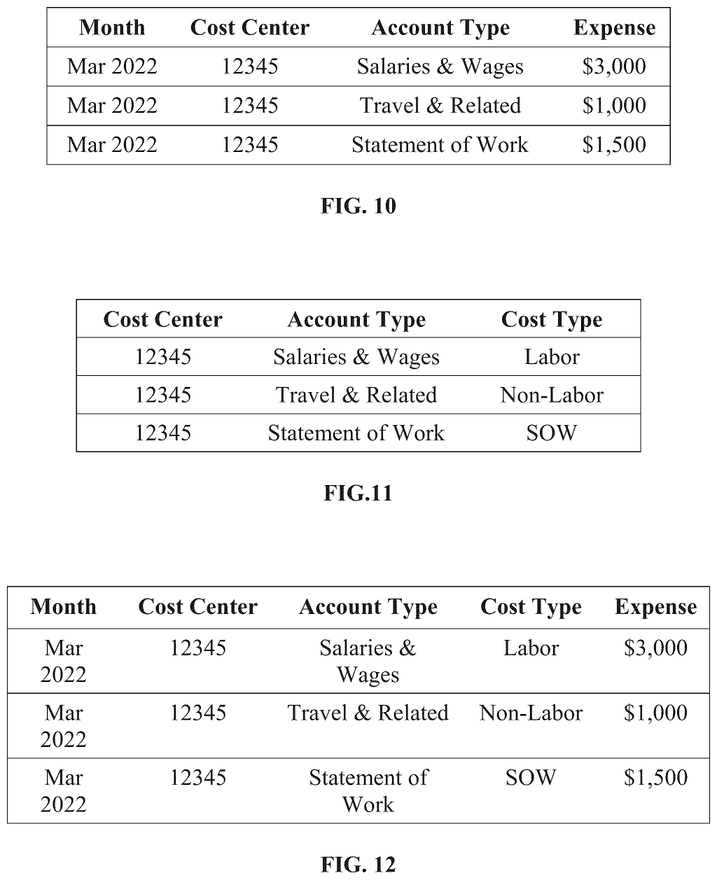

In step 500, data integration module 206 retrieves a set of cost center records from cost center database 212. In this embodiment, the cost center records to be processed are associated with the different account types for a single cost center identifier and a set time period. An example set of cost center records is shown in FIG. 10, which includes the cost center records for the Salaries & Wages, Travel & Related, and Statement of Work account types for cost center identifier 12345 that were incurred in March 2022. While this set only includes three cost center records for the sake of simplicity, it should be understood that a cost center may have any number of account types each of which has its own cost center record—e.g., the number of cost center records associated with a particular cost center identifier will typically fall in the range of about 1 to 35 records per month.

In some embodiments, data integration module 206 optionally determines the cost type associated with each of the account types of the cost center records. This is done by accessing the account type/cost type reference table in reference database 214—i.e., the reference table containing all of the account types from the accounting system 106 cross-referenced to the cost types. An example reference table is shown in FIG. 11, which shows that the Salaries & Wages account type is associated with a Labor cost type, the Travel & Related account type is associated with a Non-Labor cost type, and the Statement of Work account type is associated with an SOW cost type. It can be appreciated that two or more account types may be associated with the same cost type. The table shown in FIG. 12 depicts the cost center records of FIG. 10 as modified to add the cost types associated with the account types.

In step 502, data integration module 206 identifies the project records stored in project database 210 that are associated with the cost identifier and the set time period. These project records are referred to herein as a cost center group. In this example, the cost center group includes the project records associated with the cost center identifier 12345 that were completed in March 2022, as shown in FIG. 9.

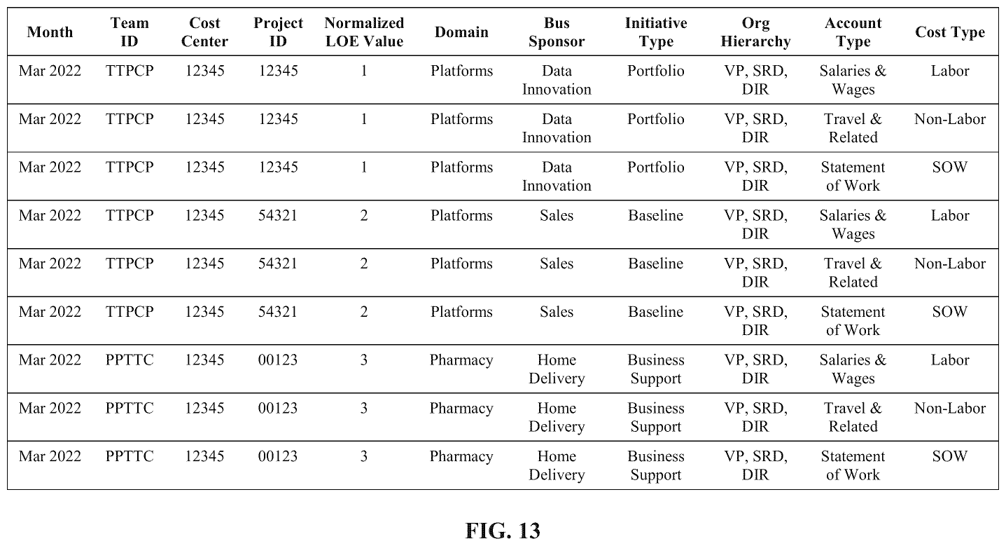

In step 504, data integration module 206 integrates the cost center records shown in FIG. 12 with the project records shown in FIG. 9 to generate integrated records by account type. The table shown in FIG. 13 depicts the integrated records. As can be seen, each project identifier (i.e., project identifiers 12345, 54321 and 00123) includes a separate row for each of the three account types contained in the cost center records-Salaries & Wages, Travel & Related, and SOW.

In step 506, it is determined whether there is another set of cost center records to be processed (e.g., the cost center records associated with a different cost center identifier for the same time period). If so, the process returns to step 500. Otherwise, the process proceeds to step 508.

In step 508, data integration module 206 sums the normalized LOE values for the project records in the cost center group to obtain a total normalized LOE value for the cost center group. In this example, the normalized LOE value for project identifier 12345 is 1, the normalized LOE value for project identifier 54321 is 2, and the normalized LOE value for project identifier 00123 is 3. Therefore, the total normalized LOE value for the cost center group is 6 (i.e., 1+2+3).

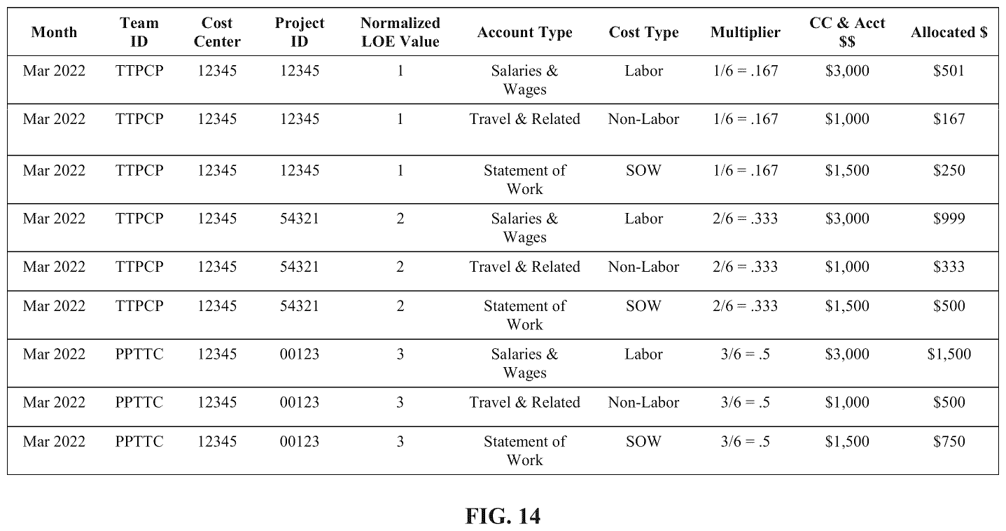

In step 510, data integration module 206 determines a multiplier for each of the project records in the cost center group. The multiplier for each project record comprises a percentage representing the normalized LOE value for the project record in relation to the total normalized LOE value for the cost center group. In this example, the multiplier for project identifier 12345 is ⅙, the multiplier for project identifier 54321 is 2/6, and the multiplier for project identifier 00123 is 3/6. The table shown in FIG. 14 depicts the multipliers applied to each of the integrated records shown in FIG. 13.

In step 512, data integration module 206 applies the multiplier for each of the project records in the cost center group to the expense amount of each of the cost center records to determine an allocated expense amount for each of the project records in the cost center group. The table shown in FIG. 14 shows the allocated expense amounts—i.e., the $3,000 expense amount for the Salaries & Wages account type is allocated $501 to project identifier 12345, $999 to project identifier 54321, and $1,500 to project identifier 00123; the $1,000 expense amount for the Travel & Related account type is allocated $167 to project identifier 12345, $333 to project identifier 54321, and $500 to project identifier 00123; and the $1,5000 expense amount for the SOW account type is allocated $250 to project identifier 12345, $500 to project identifier 54321, and $750 to project identifier 00123.

Thus, the expense amount contained in each cost center record is allocated across the cost center group based on the normalized LOE value for each of the project records in the cost center group.

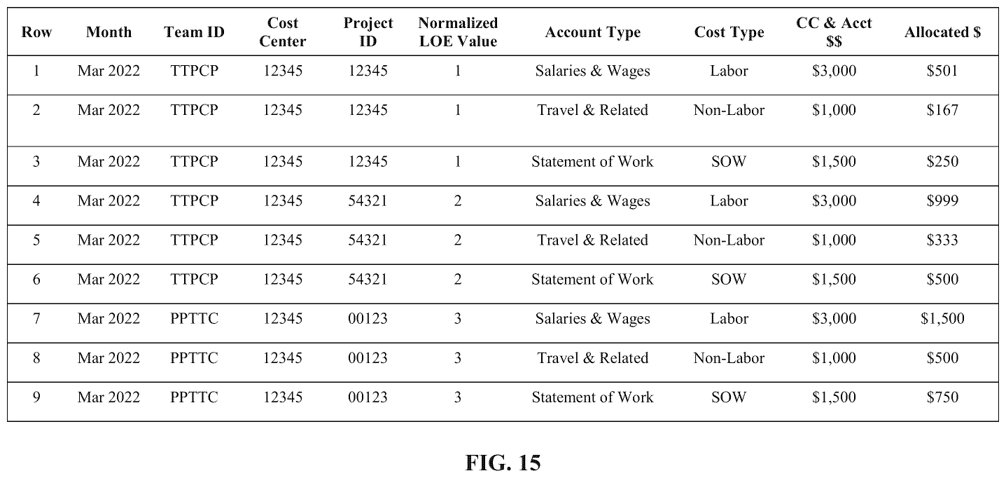

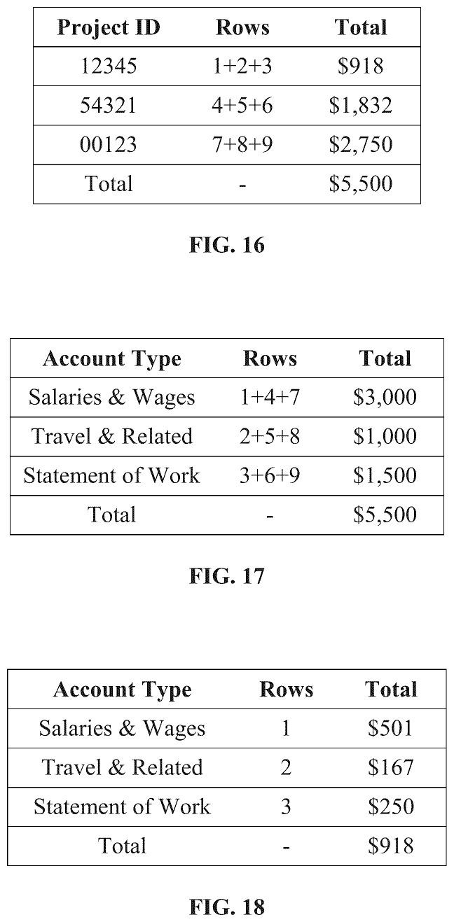

Reporting module 208 may access the integrated data and allocated expense amounts to generate one or more reports. In order to illustrate the report generation capabilities, the table of FIG. 14 is shown in FIG. 15 with row numbers added for each of the integrated records. A variety of different types of reports may be generated with the allocated expense amounts from each of these rows. For example, FIG. 16 shows a report of the total costs associated with each of the project identifiers. FIG. 17 shows a report of the total costs associated with each of the account types. FIG. 18 shows a report of the costs associated with a particular project (in this case, project identifier 12345) by account type. Of course, other report types will be apparent to one skilled in the art.

Referring to FIG. 6, an exemplary method for implementing a normalization function performed by data integration system 102 in accordance with one embodiment of the present invention is described with reference to steps 600-610.

In step 600, data integration module 206 determines a team identifier for application of the normalization function. As noted above, the normalization function is applied to project records associated with the same team identifier for a set time period. In this example, the team identifier is HMDBL2.

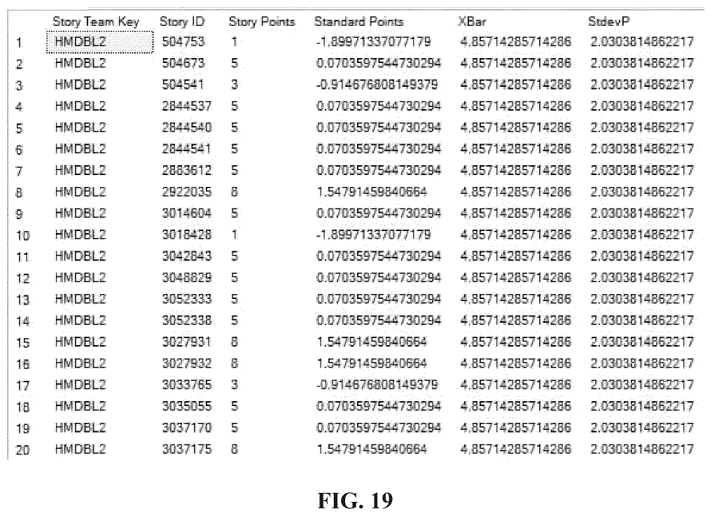

In step 602, data integration module 206 identifies the project records stored in project database 210 that are associated with the team identifier for the set time period. These project records are referred to herein as a team group. In this example, the team group includes the project records associated with the team identifier HMDBL2, a portion of which are shown in FIG. 19.

In step 604, data integration module 206 calculates a standardized LOE value for each of the project records in the team group. In this embodiment, the standardized LOE value for each of the project records in the team group is calculated in accordance with:

$$z = \frac{X - μ}{σ}$$

where
z is the standardized LOE value for a particular project record;
X is the LOE value contained in the particular project record;
μ is the mean LOE value for the project records in the team group; and
σ is the standard deviation of the LOE value for the project records in the team group.

FIG. 19 shows the LOE value (referred to as “Story Points”), the standardized LOE value (referred to as “Standard Points”), the mean LOE value (referred to as “XBar”), and the standard deviation of the LOE value (referred to as “StdevP”) for each of the project records in the team group.

It should be understood that the above equation is based on the assumption that the population to be considered is the team group—i.e., the project records stored in project database 210 that are associated with the team identifier for the set time period. One skilled in the art will understand that, in other embodiments, the team group may be considered to be a sample from the greater population of all project records associated with the team identifier.

In step 606, it is determined whether there is another team identifier to which the normalization function is to be applied. If so, the process returns to step 600. Otherwise, the process proceeds to step 608.

In step 608, data integration module 206 determines an adjustment value to be added to the standardized LOE value of all of the project records associated with all of the team identifiers. It can be appreciated that some of the standardized LOE values will have negative values and other of the standardized LOE values will have positive values. The adjustment value is a value that causes the minimum (smallest) standardized level of effort value of all of the project records to shift from a negative value to a positive value so that all of the normalized LOE values have positive values.

In step 610, data integration module 206 adds the adjustment value to the standardized LOE value for each of the project records to obtain the normalized LOE value for each of the project records.

It can be appreciated that application of the normalization function to project records on a team group-by-team group basis as described above provides normalized LOE values that account for differences between varying scales and the manner in which different teams determine the LOE values for their projects. Of course, one skilled in the art will appreciate that other types of normalization functions may be used within the scope of the present invention.

### General Information

The description set forth above provides several exemplary embodiments of the inventive subject matter. Although each exemplary embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The use of any and all examples or exemplary language (e.g., “such as” or “for example”) provided with respect to certain embodiments is intended merely to better describe the invention and does not pose a limitation on the scope of the invention. No language in the description should be construed as indicating any non-claimed element essential to the practice of the invention.

The use of the terms “comprises,” “comprising,” or any other variation thereof, are intended to cover a non-exclusive inclusion, such that a system or method that comprises a list of elements does not include only those elements, but may include other elements not expressly listed or inherent to such system or method.

Finally, while the present invention has been described and illustrated hereinabove with reference to various exemplary embodiments, it should be understood that various modifications could be made to these embodiments without departing from the scope of the invention. Therefore, the present invention is not to be limited to the specific structural configurations or methodologies of the exemplary embodiments, except insofar as such limitations are included in the following claims.

What is claimed and desired to be secured by Letters Patent is as follows:

1. A computer system, comprising:
one or more processors; and
one or more memories storing instructions that, when executed by the one or more processors, cause the one or more processors to perform a plurality of operations comprising:
(a) storing a plurality of project records based on project data received from a project management system, wherein each of the project records contains a project identifier for a project, a team identifier for a team assigned to the project, and a level of effort value indicative of an overall effort required for the team to complete the project;
(b) storing a plurality of cost center records based on accounting data received from an accounting system, wherein each of the cost center records contains a cost center identifier, an account type identifier, and an expense amount;
(c) processing each one of the project records by (i) calculating a normalized level of effort value based on the level of effort value contained in the project record and (ii) determining a cost center identifier associated with the project record; and
(d) processing each one of the cost center records by (i) identifying a cost center group comprising the project records associated with the cost center identifier contained in the cost center record and (ii) allocating the expense amount contained in the cost center record across the project records in the cost center group based on the normalized level of effort value for each of the project records in the cost center group.

2. The computer system of claim 1, further comprising maintaining a table that associates one of a plurality of team identifiers with at least one of a plurality of cost center identifiers, and wherein determining the cost center identifier associated with the project record comprises accessing the table to determine the at least one cost center identifier associated with the team identifier contained in the project record.

3. The computer system of claim 1, wherein the normalized level of effort value for each of the project records is calculated as part of a normalization function performed for each of a plurality of team identifiers.

4. The computer system of claim 3, wherein the normalization function for a particular team identifier comprises:
(a) identifying a team group comprising the project records associated with the team identifier; and
(b) calculating the normalized level of effort value for each of the project records in the team group by (i) calculating a standardized level of effort value for each of the project records in the team group, (ii) determining an adjustment value to be applied to all of the project records, and (iii) adding the adjustment value to the standardized level of effort value for each of the project records in the team group.

5. The computer system of claim 4, wherein the standardized level of effort value for each of the project records in the team group is calculated in accordance with:
$$z = \frac{X - μ}{σ}$$
where z is the standardized level of effort value for a particular project record, X is the level of effort value contained in the particular project record, μ is a mean level of effort value for the project records in the team group, and σ is a standard deviation of the level of effort value for the project records in the team group.

6. The computer system of claim 5, wherein the adjustment value comprises a value that causes a minimum standardized level of effort value of all of the project records to shift from a negative value to a positive value.

7. The computer system of claim 1, wherein allocating the expense amount contained in the cost center record across the project records in the cost center group comprises:
(a) summing the normalized level of effort values for the project records in the cost center group to obtain a total normalized level of effort value for the cost center group;
(b) determining a multiplier for each of the project records in the cost center group, wherein the multiplier for each project record comprises a percentage representing the normalized level of effort value for the project record in relation to the total normalized level of effort value for the cost center group; and
(c) applying the multiplier for each of the project records in the cost center group to the expense amount to determine an allocated expense amount for each of the project records in the cost center group.

8. A computer-implemented data processing method, comprising:
processing a plurality of project records each of which contains a project identifier for a project, a team identifier for a team assigned to the project, and a level of effort value indicative of an overall effort required for the team to complete the project, wherein each one of the plurality of project records is processed by:
calculating a normalized level of effort value based on the level of effort value contained in the project record; and
determining a cost center identifier associated with the project record; and
processing a plurality of cost center records each of which contains a cost center identifier, an account type identifier, and an expense amount, wherein each one of the cost center records is processed by:
identifying a cost center group comprising the project records associated with the cost center identifier contained in the cost center record; and
allocating the expense amount contained in the cost center record across the project records in the cost center group based on the normalized level of effort value for each of the project records in the cost center group.

9. The computer-implemented data processing method of claim 8, further comprising maintaining a table that associates one of a plurality of team identifiers with at least one of a plurality of cost center identifiers, and wherein determining the cost center identifier associated with the project record comprises accessing the table to determine the at least one cost center identifier associated with the team identifier contained in the project record.

10. The computer-implemented data processing method of claim 8, wherein the normalized level of effort value for each of the project records is calculated as part of a normalization function performed for each of a plurality of team identifiers.

11. The computer-implemented data processing method of claim 10, wherein the normalization function for a particular team identifier comprises:
identifying a team group comprising the project records associated with the team identifier; and
calculating the normalized level of effort value for each of the project records in the team group by:
calculating a standardized level of effort value for each of the project records in the team group;
determining an adjustment value to be applied to all of the project records; and
adding the adjustment value to the standardized level of effort value for each of the project records in the team group.

12. The computer-implemented data processing method of claim 11, wherein the standardized level of effort value for each of the project records in the team group is calculated in accordance with:
$$z = \frac{X - μ}{σ}$$
where z is the standardized level of effort value for a particular project record, X is the level of effort value contained in the particular project record, μ is a mean level of effort value for the project records in the team group, and σ is a standard deviation of the level of effort value for the project records in the team group.

13. The computer-implemented data processing method of claim 12, wherein the adjustment value comprises a value that causes a minimum standardized level of effort value of all of the project records to shift from a negative value to a positive value.

14. The computer-implemented data processing method of claim 8, wherein allocating the expense amount contained in the cost center record across the project records in the cost center group comprises:
summing the normalized level of effort values for the project records in the cost center group to obtain a total normalized level of effort value for the cost center group;
determining a multiplier for each of the project records in the cost center group, wherein the multiplier for each project record comprises a percentage representing the normalized level of effort value for the project record in relation to the total normalized level of effort value for the cost center group; and
applying the multiplier for each of the project records in the cost center group to the expense amount to determine an allocated expense amount for each of the project records in the cost center group.

15. A computer-implemented data processing method, comprising:
processing a plurality of project records each of which contains a project identifier for a project, a team identifier for a team assigned to the project, and a level of effort value indicative of an overall effort required for the team to complete the project, wherein each one of the plurality of project records is processed by:
calculating a normalized level of effort value based on the level of effort value contained in the project record; and
determining a cost center identifier associated with the project record; and
processing a plurality of cost center records each of which contains a cost center identifier, an account type identifier, and an expense amount, wherein each one of the cost center records is processed by:
identifying a cost center group comprising the project records associated with the cost center identifier contained in the cost center record;
allocating the expense amount contained in the cost center record across the project records in the cost center group by:
summing the normalized level of effort values for the project records in the cost center group to obtain a total normalized level of effort value for the cost center group;
determining a multiplier for each of the project records in the cost center group, wherein the multiplier for each project record comprises a percentage representing the normalized level of effort value for the project record in relation to the total normalized level of effort value for the cost center group; and
applying the multiplier for each of the project records in the cost center group to the expense amount to determine an allocated expense amount for each of the project records in the cost center group.

16. The computer-implemented data processing method of claim 15, further comprising maintaining a table that associates one of a plurality of team identifiers with at least one of a plurality of cost center identifiers, and wherein determining the cost center identifier associated with the project record comprises accessing the table to determine the at least one cost center identifier associated with the team identifier contained in the project record.

17. The computer-implemented data processing method of claim 15, wherein the normalized level of effort value for each of the project records is calculated as part of a normalization function performed for each of a plurality of team identifiers.

18. The computer-implemented data processing method of claim 17, wherein the normalization function for a particular team identifier comprises:
identifying a team group comprising the project records associated with the team identifier; and
calculating the normalized level of effort value for each of the project records in the team group by:
calculating a standardized level of effort value for each of the project records in the team group;
determining an adjustment value to be applied to all of the project records; and
adding the adjustment value to the standardized level of effort value for each of the project records in the team group.

19. The computer-implemented data processing method of claim 18, wherein the standardized level of effort value for each of the project records in the team group is calculated in accordance with:
$$z = \frac{X - μ}{σ}$$
where z is the standardized level of effort value for a particular project record, X is the level of effort value contained in the particular project record, μ is a mean level of effort value for the project records in the team group, and σ is a standard deviation of the level of effort value for the project records in the team group.

20. The computer-implemented data processing method of claim 19, wherein the adjustment value comprises a value that causes a minimum standardized level of effort value of all of the project records to shift from a negative value to a positive value.
